(19) United States
(12) Patent Application Publication
(10) Pub. No.: US 2026/0210533 A1
(43) Pub. Date: Jul. 23, 2026

(54) CENTRAL LUMINOUS STRUCTURE OF LAMP CONNECTOR

(71) Applicant: Zhongshan Gaoneng Lighting Technology Co.,Ltd., Zhongshan (CN)

(72) Inventor: ZHENGLANG WU, Zhongshan (CN)

(21) Appl. No.: 19/568,690

(22) Filed: Mar. 16, 2026

(30) Foreign Application Priority Data
Feb. 3, 2026 (CN) 202620155696.3

(51) Int. Cl. F21V 21/005; F21V 3/00; F21V 7/00

(52) U.S. Cl. CPC F21V 21/005; F21V 3/00; F21V 7/0066

(57) ABSTRACT

Provided is a central light emitting structure of a lamp connector, which includes a connector body that allows one end of two or more lamps to be connected in series to the connector body; a light emitting component provided inside the connector body; a transparent top cover that is connected to the connector body, the light emitting component is configured to project light outward through the transparent top cover. By providing the light emitting component inside the connector body and projecting light outward the transparent top cover, a problem of dark spots in a connection area caused by a non-light emission connector of traditional lamps has been effectively solved. As a result, the lighting at the connection points of a plurality of lamps is homogenized, thereby improving the coordination and aesthetics of the overall lighting system. The connector body has a lighting function and avoids visual discontinuity.

### CROSS-REFERENCE TO RELATED APPLICATIONS

This application claims priority to Chinese Patent Application No. 202620155696.3, filed on Feb. 3, 2026, which is hereby incorporated by reference in its entirety.

### TECHNICAL FIELD

The present disclosure relates to the field of lighting technologies, and in particular, to a central luminous structure of a lamp connector.

### BACKGROUND

In lighting system design, the combination installation of a plurality of lamps is a common requirement, usually relying on connectors to achieve electrical and mechanical connections. The existing connector structure only focuses on conductive function and does not integrate any light emitting components inside, resulting in the inability to generate light output in a connection area. When a plurality of lamps are connected in series through such connectors, a clear light interruption area is formed at a connection point, resulting in visual dark spots. This type of dark spot damages the continuity of lighting, resulting in uneven overall lighting effects, especially in decorative lighting scenes, significantly affecting aesthetic coordination, reducing product visual quality and user experience. Besides that, traditional connectors lack guidance or enhancement mechanisms for light, which further exacerbates the problem of dark spots and creates a sense of disconnection in key connection areas of the lighting system, rendering it difficult to meet the requirements of modern lighting for seamless visual effects.

### SUMMARY

In order to overcome the shortcomings of existing technology, the present disclosure provides a central light emitting structure for a lamp connector.

The technical solution adopted by the present disclosure to solve its technical problem is as follows.

A central light emitting structure for a lamp connector, including:
a connector body that allows one end of two or more lamps to be connected in series to the connector body;
a light emitting component that is provided inside the connector body;
a transparent top cover that is connected to the connector body, where the light emitting component is configured to project light outward through the transparent top cover.

In some embodiments of the present disclosure, the light emitting component includes a reflector provided inside the connector body, where the reflector is configured to reflect the light emitted by the lamps in a direction of the connector body out of the transparent top cover.

In some embodiments of the present disclosure, the light emitting component includes a light emitting element provided inside the connector body.

In some embodiments of the present disclosure, the light emitting component includes an installation base provided in the connector body, and the light emitting element is provided on the installation base.

In some embodiments of the present disclosure, the installation base is a transparent cover.

In some embodiments of the present disclosure, a limit structure is further provided between the transparent cover and the light emitting element, where the limit structure includes a plurality of limit protrusions protruding from an inner side wall of the transparent cover, and the light emitting element extends into the transparent cover and passes through the limit protrusions to abut against an upper surface of the limit protrusions.

In some embodiments of the present disclosure, a clamping structure is further provided between the light emitting component and the connector body.

In some embodiments of the present disclosure, the clamping structure includes a plurality of clamp notches provided on the connector body and a hook protruding from a lower end of the light emitting component and configured to be correspondingly embedded in the clamp notches.

In some embodiments of the present disclosure, an installation limit mechanism is further provided between the connector body and the transparent top cover.

In some embodiments of the present disclosure, the installation limit mechanism includes a plurality of clamping slots provided on the connector body and a plurality of elastic clamping parts provided at a lower end of the transparent top cover and configured to be correspondingly embedded in the clamping slots.

The beneficial effects of the present disclosure are: the structure of this application is simple, and by providing the light emitting component inside the connector body and cooperating with the transparent top cover to project light outward, it effectively solves the problem of dark spots in the connection area caused by the non-light emission of traditional lamp connectors. As a result, the lighting at the connection points of a plurality of lamps is homogenized, improving the coordination and aesthetics of the overall lighting system. This structure enables the connector body itself to have lighting function, avoiding visual discontinuity and improving the overall visual effect of the lamp.

### BRIEF DESCRIPTION OF DRAWINGS

In order to provide a clearer explanation of the technical solution in the embodiments of the present application, a brief introduction will be given to the drawings required for the description of the embodiments. It is obvious that the drawings described below are only some embodiments of the present application. For those skilled in the art, other drawings can be obtained based on these drawings without creative work.

FIG. 1 is a schematic structural diagram of a central light emitting structure for a lamp connector in embodiment 1 of the present disclosure.

FIG. 2 is an exploded view of the central light emitting structure for a lamp connector in embodiment 1 of the present disclosure.

FIG. 3 is a schematic diagram of an installation process of the central light emitting structure for a lamp connector in embodiment 1 of the present disclosure.

FIG. 4 is an enlarged schematic diagram of point A in FIG. 3.

FIG. 5 is a schematic diagram of a use state of the central light emitting structure for a lamp connector in embodiment 1 of the present disclosure.

FIG. 6 is an exploded view of the central light emitting structure for a lamp connector in embodiment 2 of the present disclosure.

FIG. 7 is an exploded view of the central light emitting structure for a lamp connector in embodiment 3 of the present disclosure.

FIG. 8 is a schematic diagram of a cross-sectional structure of the central light emitting structure for a lamp connector in embodiment 3 of the present disclosure.

FIG. 9 is a schematic diagram of the central light emitting structure for a lamp connector in embodiment 4 of the present disclosure.

### DESCRIPTION OF EMBODIMENTS

The technical solution of the present disclosure will be described in detail below with reference to the accompanying drawings and embodiments.

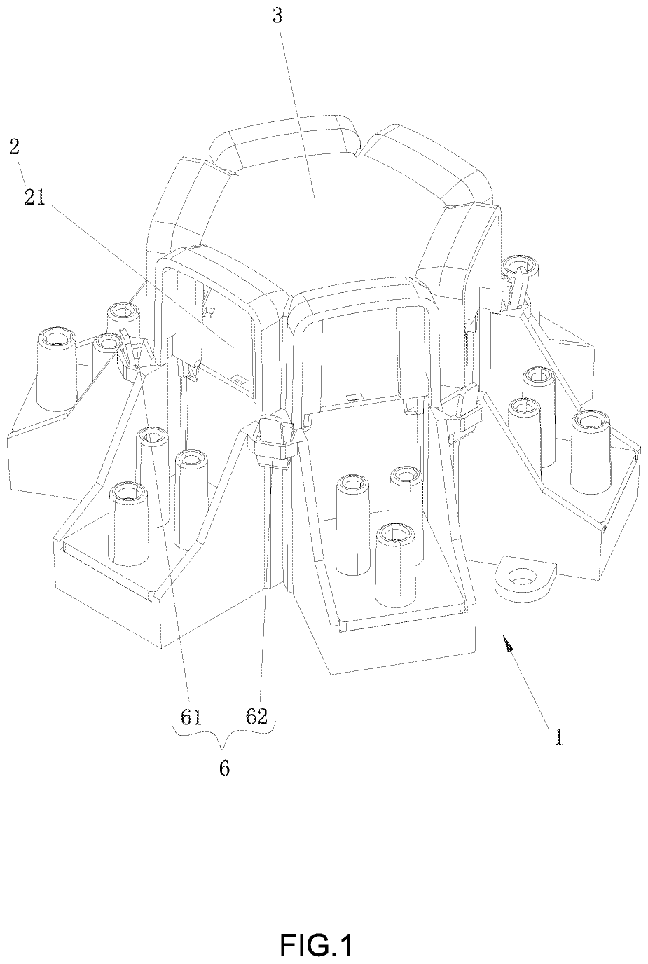

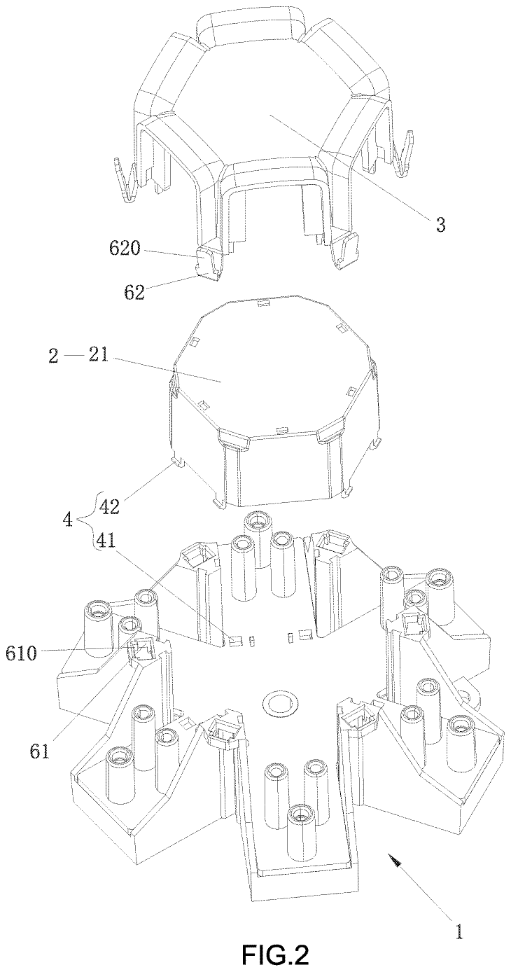

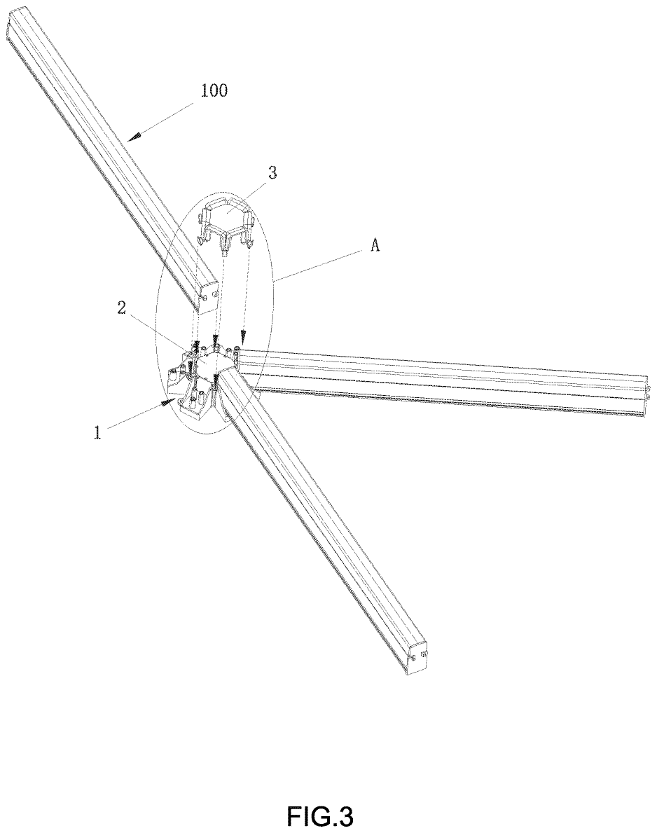

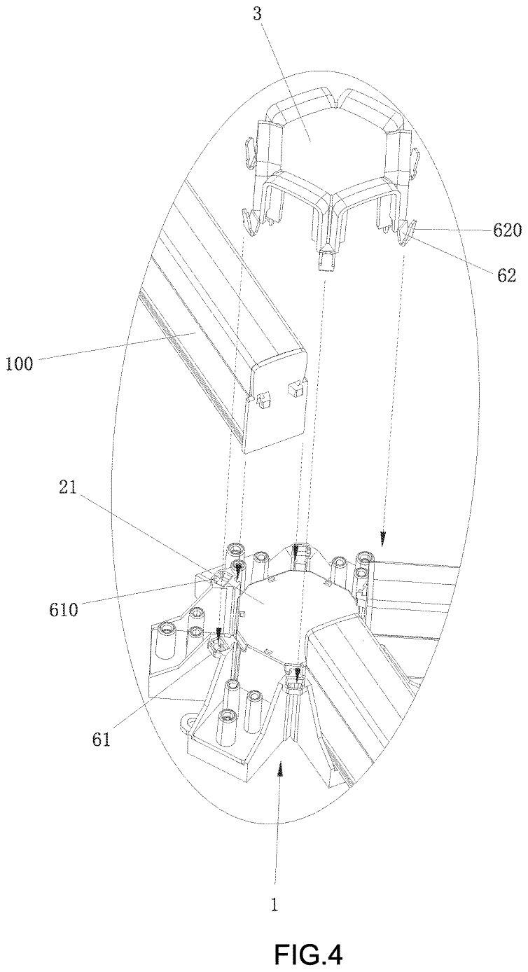

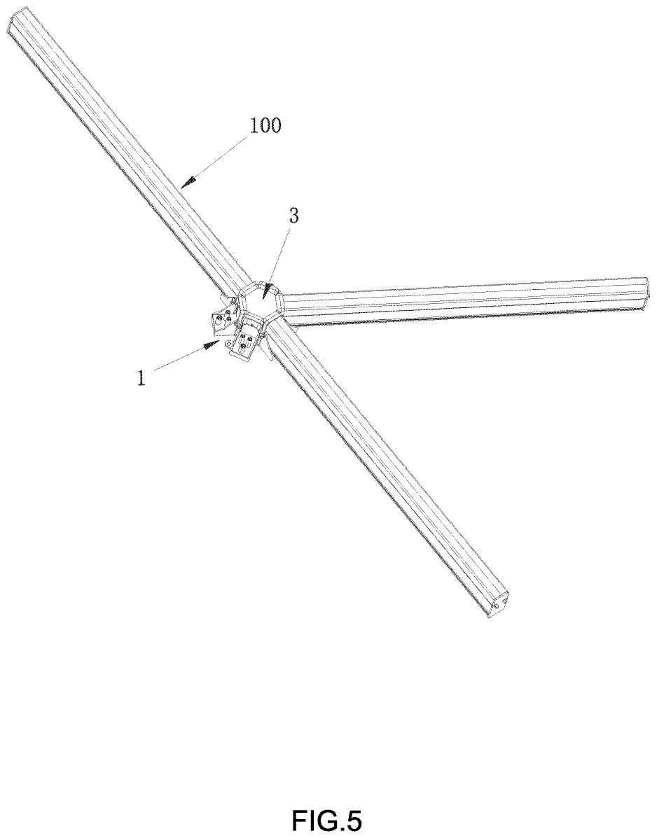

Please refer to FIGS. 1 to 5. Embodiment 1 of the present application provides a central light emitting structure for a lamp connector, including:
a connector body 1 that allows one side of two or more lamps 100 to be connected in series to the connector body 1;
a light emitting component 2 that is provided inside the connector body 1;
a transparent top cover 3 that is connected to the connector body 1, the light emitting component 2 can project light through the transparent top cover 3.

In this embodiment 1, the connector body 1 is a common existing technology in this field, made of materials with certain strength and insulation properties to ensure the stability and safety of electrical connections. This application is briefly applied and will not be described in detail here.

In an implementation mode, the connector body 1 in this embodiment can be designed as a hollow structure, thereby forming a cavity inside for accommodating the light emitting component 2. A plurality of interfaces 10 can be provided on this body for access of the lamps 100. The material of the connector body 1 can be selected as engineering plastic or metal alloy to meet the requirements of strength, insulation, or heat dissipation. For example, the connector body 1 can be integrally formed into a circular or square housing, with a plurality of slots or threaded holes distributed in a circumferential direction for mechanical fixation and electrical connection of the lamps 100.

In this embodiment 1, the lamps 100 are a common existing technology in this field, which are connected through the connector body 1 to achieve power transmission as a lighting device. One end of each of the lamps 100 is connected to the interfaces 10 on the connector body 1, thereby achieving electrical connection between a plurality of lamps 100 and forming an integrated lighting system.

In an implementation mode, one end of the lamps 100 can be designed as a structure with a plug or a wiring terminal. The plug or wiring terminal can be inserted or fixed into a preset interface 10 on the connector body 1. Inside the connector body 1, conductive busbars or wiring columns can be provided to electrically connect all connected lamps 100 in series. For example, a connection end of the lamps 100 can be connected to the wires or contacts inside the connector body 1 using simple crimping or screw fixing methods, thereby achieving the transmission of electrical energy.

In this embodiment 1, the transparent top cover 3 can be made of a material with transparent properties, allowing the light generated by the light emitting component 2 to penetrate and project into an external space and also providing protection for the internal components.

By installing the light emitting component 2 inside the connector body 1 and cooperating with the transparent top cover 3 to project light outward, the problem of dark spots in a connection area caused by the non-light emission of traditional lamp connectors has been effectively solved. As a result, the lighting at the connection points of a plurality of lamps 100 is homogenized, improving the overall coordination and aesthetics of the lighting system. This structure enables the connector body 1 to have lighting function, avoiding visual discontinuity and improving the overall visual effect of the lamps.

In an implementation mode, the light emitting component 2 includes a reflector 21 provided in the connector body 1, the reflector 21 can reflect the light emitted from the lamp 100 in a direction of the connector body 1 out of the transparent top cover 3.

By providing the reflector 21, it is possible to effectively collect and redirect light emitted from the connection end of the lamps 100, converge and guide the light that may have scattered or directly emitted, causing uneven light, and evenly project it outward through the transparent top cover 3. This significantly improves the lighting uniformity of the connection part of the lamps, eliminates possible dark spots, and thus enhances the overall lighting effect and visual aesthetics.

In an implementation mode, there is a clamping structure 4 between the light emitting component 2 and the connector body 1.

By providing the clamping structure 4, the light emitting component 2 can be firmly fixedly connected inside the connector body 1, avoiding the shaking or displacement of the light emitting component 2 due to unstable installation, ensuring the accuracy of a light reflection path, avoiding uneven dark spots or light spots caused by a displacement of the light emitting component 2, and thereby improving the optical performance and overall aesthetics of the entire central light emitting structure for a lamp connector, rendering the lighting of the connection part of the lamps more coordinated and consistent.

In an implementation mode, the clamping structure 4 includes a plurality of clamp notches 41 provided on the connector body 1 and a hook 42 protruding from a lower end of the light emitting component 2 and configured to be correspondingly embedded in the clamp notches 41.

By providing the clamp notches 41 and the hook 42, when the light emitting component 2 is provided into the connector body 1, the protruding hook 42 at its lower end will align with the clamp notches 41 provided on the connector body 1. By applying appropriate pressure, the hook 42 can be smoothly embedded into the clamp notches 41 to form a tight mechanical fit, thereby firmly fixing the light emitting component 2 on the connector body 1, thereby providing a reliable fixing point to ensure a stable position of the light emitting component 2 inside the connector body 1, thus effectively avoiding loosening or falling off problems caused by weak fixation.

Besides that, by using a clamp connection method, no additional fasteners or tools are required. The hook 42 is simply aligned on the light emitting component 2 with the clamp notches 41 and it is pressed to complete the installation, thereby significantly improving the convenience and efficiency of assembly. When maintenance or replacement of the light emitting component 2 is required, it can be relatively easy to disconnect the clamp through specific operations, rendering it convenient for disassembly and reinstallation.

In this embodiment 1, the hook 42 is correspondingly protruding from a lower end of the reflector 21.

In an implementation mode, an installation limit mechanism 6 is provided between the connector body 1 and the transparent top cover 3.

By providing the installation limit mechanism 6, the transparent top cover 3 is firmly fixed onto the connector body 1. This stable fixing method effectively solves the problem of looseness, displacement, or detachment that may occur during the assembly or use of the transparent top cover 3. In view of this, the path and angle of the light projected by the light emitting component 2 through the transparent top cover 3 are accurately maintained, thereby ensuring the uniformity and consistency of the light projection, avoiding local dark spots or uneven light spots caused by the displacement of the transparent top cover 3, and significantly improving the overall aesthetics and lighting effect of the central light emitting structure for a lamp connector. At the same time, providing the installation limit mechanism 6 greatly enhances the reliability and service life of the central light emitting structure for a lamp connector.

In an implementation mode, the installation limit mechanism 6 includes a plurality of clamping slots 61 provided on the connector body 1 and a plurality of elastic clamping parts 62 provided at a lower end of the transparent top cover 3 and configured to be correspondingly embedded in the clamping slots 61.

By providing the clamping slot 61 and the elastic clamping parts 62, the elastic clamping part 62 utilizes its elastic properties to automatically lock and form a reliable mechanical connection after being embedded into the clamping slot 61, thereby effectively preventing the transparent top cover 3 from loosening or falling off due to vibration or external forces. This clamping method not only simplifies an assembly process and avoids the complexity caused by traditional threaded connections or adhesives, but also ensures the fixed position of the transparent top cover 3 during long-term use, thereby ensuring the stable and uniform direction of the light projected by the light emitting component 2, avoiding uneven dark spots or light spots caused by the displacement of the transparent top cover 3, and further improving the aesthetics and practicality of the central light emitting structure for a lamp connector.

In an implementation mode, one side wall of the clamping slot 61 is further provided with a clamp gap 610, and the elastic clamping part 62 is also provided with a pressing piece 620 that can be embedded into the clamp gap 610.

When the connector body 1 is assembled with the transparent top cover 3, the pressing piece 620 on the elastic clamping part 62 can accurately embedded into the predetermined clamp gap 610 on a side wall of the clamping slot 61 after entering the clamping slot 61. This embedded locking mechanism adds additional mechanical locking points based on an original clamp connection, thereby effectively preventing the elastic clamping part 62 from accidentally loosening or falling out of the clamping slot 61 when subjected to vibration, impact, or external tension. At the same time, the design of the pressing piece 620 also provides users with clear pressing operation interface, rendering the installation and disassembly process more convenient and intuitive. In view of this, this solution significantly improves the reliability and stability of the assembly connection between the connector body 1 and the transparent top cover 3, ensuring the firmness of the central light emitting structure for a lamp connector in long-term use, thereby avoiding dark spots or aesthetic problems caused by loose connections, and further optimizing the overall structural integrity and user experience of the lamps.

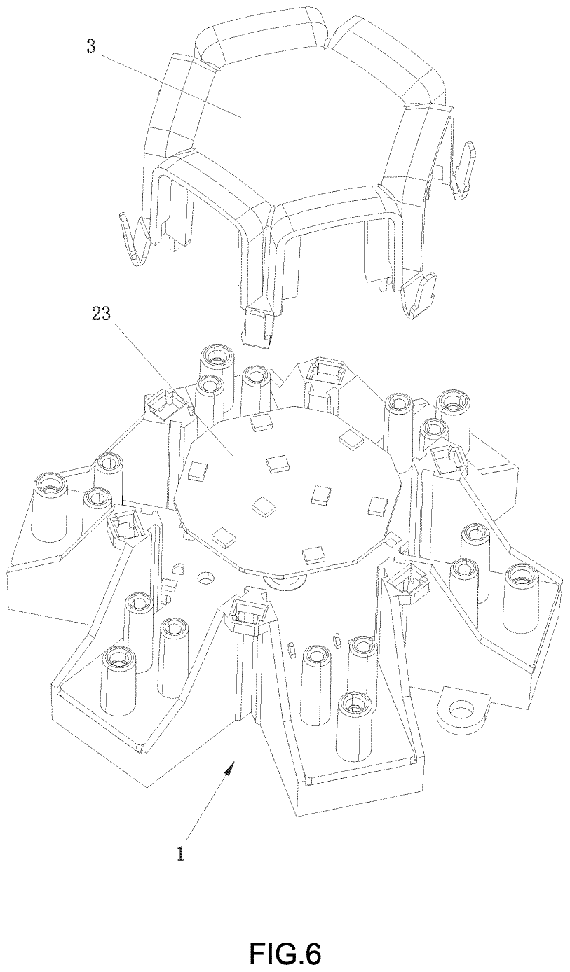

In an implementation mode, as shown in FIG. 6, the present application further provides embodiment 2. In embodiment 2, this embodiment is basically the same as embodiment 1. For the sake of simplicity, only a main difference between its structure and embodiment 1 will be explained. The parts not explained in this embodiment are the same as those in embodiment 1, with the difference being as follows.

The light emitting component 2 is a light emitting element 23 provided in the connector body 1.

By providing the light emitting element 23 as an independent central light source, it can directly provide active illumination in a central area of the connector body 1, effectively solving the problem of insufficient lighting and dark spots in a central area of the connector body 1. Which significantly improves the overall luminous uniformity and aesthetics of the lamp connector, so that when a plurality of lamps are connected, there are no more uncoordinated dark spots in the connection part, and an overall visual effect is more harmonious and unified.

In this embodiment 2, the light emitting element 23 can be a light emitting lamp board.

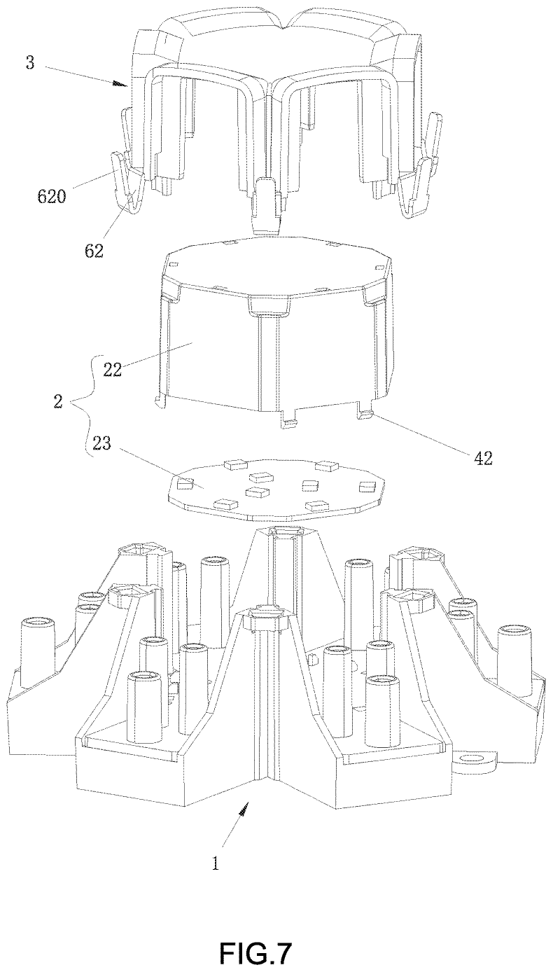

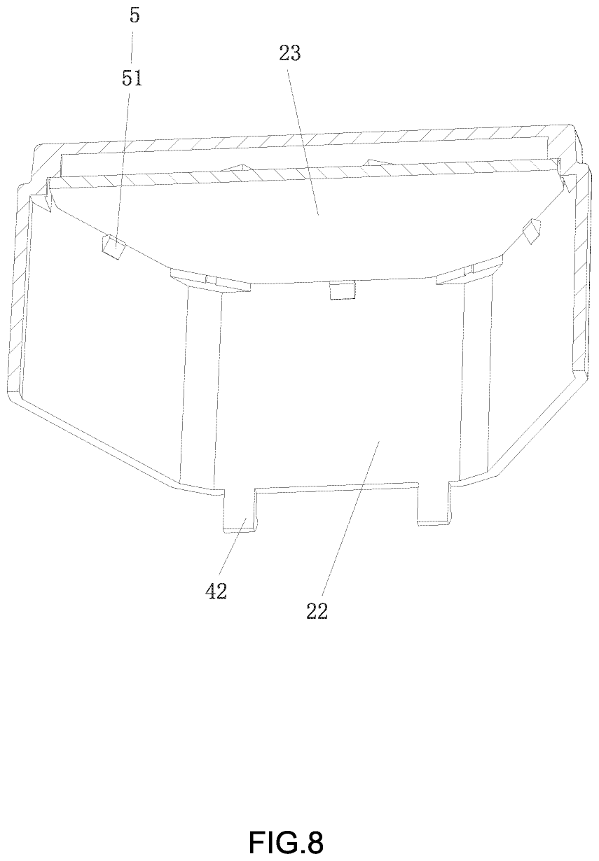

In an implementation mode, as shown in FIGS. 7-8, the present application further provides embodiment 3. In embodiment 3, this embodiment is basically the same as embodiment 2. For the sake of simplicity, only a main differences between its structure and embodiment 2 are explained. The parts not explained in this embodiment are the same as those in embodiment 2, with the difference being as follows.

The light emitting component 2 includes an installation base provided in the connector body 1, and the light emitting element 23 is provided on the installation base.

The installation base is a transparent cover 22.

By providing the light emitting element 23 as an independent central light source, it can directly provide active illumination in the central area of the connector body 1, effectively solving the problem of insufficient lighting and dark spots in the central area of the connector body 1. Which significantly improves the overall luminous uniformity and aesthetics of the lamp connector, so that when a plurality of lamps are connected, there are no more uncoordinated dark spots in the connection part, and the overall visual effect is more harmonious and unified.

In an implementation mode, a limit structure 5 is provided between the transparent cover 22 and the light emitting element 23, the limit structure 5 includes a plurality of limit protrusions 51 protruding from an inner side wall of the transparent cover 22. The light emitting element 23 extends into the transparent cover 22 and passes through the limit protrusions 51 to abut against an upper surface of the limit protrusions 51.

By providing the limit structure 5, the light emitting element 23 can be effectively and reliably mechanically fixed. This ensures that the light emitting element 23 remains in a preset position during installation and use, thereby avoiding displacement or loosening caused by factors such as vibration, impact, or gravity. This stable fixing method ensures that the electrical connection of the light emitting element 23 is always reliable, thereby eliminating flickering or interruption caused by poor contact and ensuring continuous and stable light-emitting output. Besides that, due to a precise alignment of an optical center of the light emitting element 23 with a geometric center of the transparent cover 22, the emitted light can be uniformly and accurately projected onto the transparent cover 22 and the transparent top cover 3, thereby effectively avoiding a problem of dark spots or uneven light spots in the illumination area, significantly improving the overall illumination effect and visual comfort. Furthermore, a stable fixation reduces relative movement and wear between the light emitting element 23 and the transparent cover 22, reduces the risk of component damage, and significantly improves the reliability and service life of the entire light emitting component 2.

By providing the limit protrusion 51, clear physical support and positioning points are provided for the light emitting element 23. When the light emitting element 23 extends into the transparent cover 22 and passes through these limit protrusions 51, its installation path is effectively guided, ensuring that the light emitting element 23 can be accurately placed in a predetermined position of the transparent cover 22. Subsequently, the light emitting element 23 is fixed by abutting against the upper surface of the limit protrusions 51. This abutting action provides stable support in a vertical direction, effectively preventing the light emitting element 23 from loosening or displacement due to vibration, impact, or other external forces during the operation of the central light emitting structure for a lamp connector. This precise positioning and reliable fixing mechanism fundamentally solve the problem of unstable installation of the light emitting element 23, ensuring that the light emitting element 23 can stably emit uniform light, avoiding unstable light projection or dark spots caused by shaking, and significantly improving the overall luminous effect and aesthetics of the central light emitting structure for a lamp connector.

In this embodiment 3, the hook 42 is correspondingly protruding from a lower end of the transparent cover 22.

In this embodiment 3, the light emitting element 23 can be a light emitting lamp board.

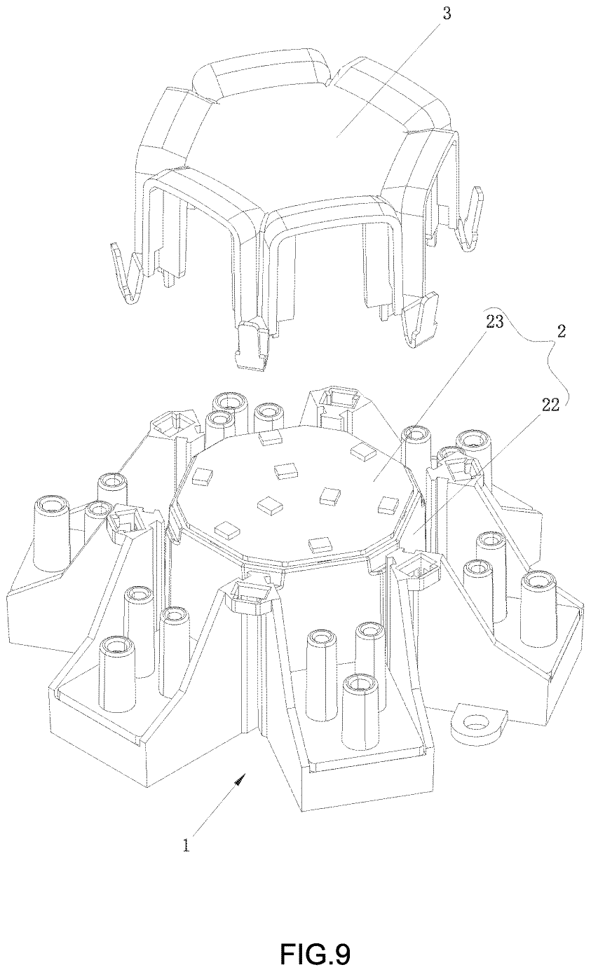

In an implementation mode, as shown in FIG. 9, the present application further provides embodiment 4. In embodiment 4, this embodiment is basically the same as embodiment 3. For the sake of simplicity, only a main difference between its structure and embodiment 3 will be explained. The parts not explained in this embodiment are the same as those in embodiment 3, with the difference being as follows.

The light emitting element 23 is provided at an upper end of the installation base.

In summary, the embodiment of the present application effectively solves the problem of dark spots in a connection area caused by the non-light emission of traditional lamp connectors by providing the light emitting component 2 inside the connector body 1 and cooperating with the transparent top cover 3 to project light outward. As a result, the lighting at the connection point of a plurality of lamps 100 is homogenized, improving the overall coordination and aesthetics of the lighting system. This structure enables the connector body 1 to have lighting function, thereby avoiding visual discontinuity and improving the overall visual effect of the lamp.

The above description is only an embodiment of the present disclosure and does not limit the scope of the present disclosure. Any equivalent structure made using the content, specification and drawings of the present disclosure, or directly or indirectly applied in other related technical fields, is also included in the protection scope of the present disclosure.

What is claimed is:

1. A central light emitting structure for a lamp connector, comprising:
a connector body that allows one end of two or more lamps to be connected in series to the connector body;
a light emitting component that is provided inside the connector body;
a transparent top cover that is connected to the connector body, wherein the light emitting component is configured to project light outward through the transparent top cover.

2. The central light emitting structure for a lamp connector according to claim 1, wherein the light emitting component comprises a reflector provided inside the connector body, wherein the reflector is configured to reflect the light emitted by the lamps in a direction of the connector body out of the transparent top cover.

3. The central light emitting structure for a lamp connector according to claim 1, wherein the light emitting component comprises a light emitting element provided inside the connector body.

4. The central light emitting structure for a lamp connector according to claim 3, wherein the light emitting component comprises an installation base provided in the connector body, and the light emitting element is provided on the installation base.

5. The central light emitting structure for a lamp connector according to claim 4, wherein the installation base is a transparent cover.

6. The central light emitting structure for a lamp connector according to claim 5, wherein a limit structure is further provided between the transparent cover and the light emitting element, wherein the limit structure comprises a plurality of limit protrusions protruding from an inner side wall of the transparent cover, and the light emitting element extends into the transparent cover and passes through the limit protrusions to abut against an upper surface of the limit protrusions.

7. The central light emitting structure for a lamp connector according to claim 1, wherein a clamping structure is further provided between the light emitting component and the connector body.

8. The central light emitting structure for a lamp connector according to claim 7, wherein the clamping structure comprises a plurality of clamp notches provided on the connector body and a hook protruding from a lower end of the light emitting component and configured to be correspondingly embedded in the clamp notches.

9. The central light emitting structure for a lamp connector according to claim 1, wherein an installation limit mechanism is further provided between the connector body and the transparent top cover.

10. The central light emitting structure for a lamp connector according to claim 9, wherein the installation limit mechanism comprises a plurality of clamping slots provided on the connector body and a plurality of elastic clamping parts provided at a lower end of the transparent top cover and configured to be correspondingly embedded in the clamping slots.
